(19) United States
(12) Patent Application Publication
(10) Pub. No.: US 2008/0056143 A1
(43) Pub. Date: Mar. 6, 2008

(54) METHOD AND APPARATUS TO FACILITATE USER INTERFACE CONFIGURATION-BASED ACCOMMODATION OF OPERATIONAL CONSTRAINTS

(75) Inventors: Ajit Mathews, Plantation, FL (US); Kenneth W. Douros, South Barrington, IL (US); Jon Godston, Chicago, IL (US); Thomas C. Hill, Crystal Lake, IL (US); Jiji Mathews, Plantation, FL (US); Steven J. Nowlan, South Barrington, IL (US); Carlton J. Sparrell, Marblehead, MA (US); Hoi L. Young, Lake Villa, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/469,340

(22) Filed: Aug. 31, 2006

(51) Int. Cl. H04J 1/16

(52) U.S. Cl. 370/250

(57) ABSTRACT

When a wireless two-way communications device that has a plurality of user interfaces (and where at least two of these interfaces comprise different interface modalities) receives (101, 201) non-user input regarding an operational constraint (such as, but not limited to, an environmentally-sourced or an internally-sourced operational constraint), an automatic determination (102, 202) will follow regarding a plurality of differing user interface operational configurations as will comply with the operational constraint. One or more of these operational configurations are then presented (103, 203) to a user of the device in order to prompt provision of a user instruction regarding use of such operational configurations. Upon receiving (104, 204) a corresponding instruction from the user, the corresponding operational configuration is used (105, 205) to thereby accommodate the operational constraint in a manner that is relatively satisfactory to the user.

### TECHNICAL FIELD

This invention relates generally to user interfaces and more particularly to wireless two-way communications device user interfaces.

### BACKGROUND

User interfaces of various kinds are known in the art. Many of these user interfaces differ from one another in various ways with respect, for example, to interface modality. In many cases a single end-user platform, such as a wireless two-way communication is device, will support multiple different user interfaces. This, in turn, often permits a user to select from amongst a plurality of different user interface configuration possibilities.

Non-user sourced operational constraints are increasingly encountered by such devices. Such operational constraints may comprise, for example, environmentally-sourced operational constraints and/or internally-sourced operational constraints. The operational constraint itself may comprise a legally-required constraint, a societally-required constraint, or the like.

At present, in many cases, an end user must take personal unilateral actions to comply with such operational constraints when and as they arise. This can comprise, for example, selecting a particular user interface operational configuration. In at least some application settings, this can comprise a confusing, distracting, and/or burdensome action or responsibility. In at least some instances a given end user may be ignorant of what options may be available when making such a change. As a result, in at least some cases, an end user can find themselves operating in a non-compliant manner with respect to one or more operational constraints and/or operating in a manner that is relatively unsatisfactory to the end user.

### BRIEF DESCRIPTION OF THE DRAWINGS

The above needs are at least partially met through provision of the method and apparatus to facilitate user interface configuration-based accommodation of operational constraints described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises an architectural layer view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, when a wireless two-way communications device that has a plurality of user interfaces (and where at least two of these interfaces comprise differing interface modalities) receives non-user input regarding an operational constraint (such as, but not limited to, an environmentally-sourced or an internally-sourced operational constraint), an automatic determination will follow regarding a plurality of differing user interface operational configurations as will comply with the operational constraint. One or more of these operational configurations are then presented to a user of the device in order to prompt provision of a user instruction regarding use of such operational configurations. Upon receiving a corresponding instruction from the user, the device uses the corresponding operational configuration to thereby accommodate the operational constraint in a manner that is relatively satisfactory to the user.

In particular, by these teachings, a user can become apprised of an existing non-user-based operational constraint. This user can further be apprised of more than one way by which their device can effectively comply with such an operational constraint. This, in turn, is more likely to lead to relative user satisfaction as the user has an ability to at least select an approach that is least objectionable and/or most favorable with respect to the user's objective and subjective needs, preferences, and requirements.

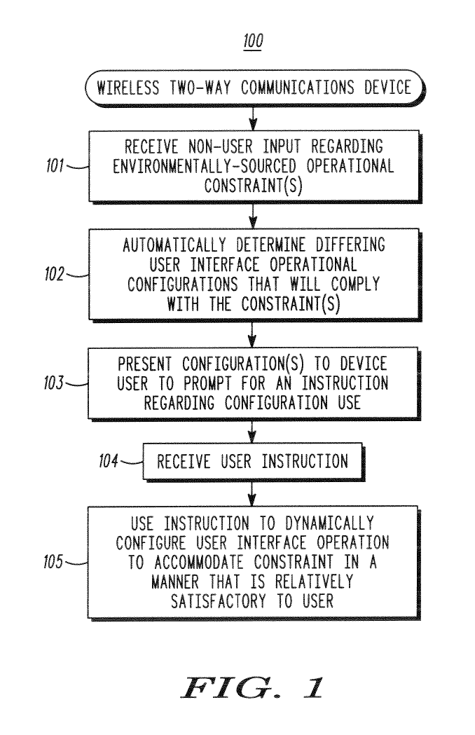

These and other benefits may become clearer upon making a thorough review and study of the following detailed description. Referring now to the drawings, and in particular to FIG. 1, these teachings will be described in context with a wireless two-way communications device having a plurality of user interfaces wherein at least two of the plurality of user interfaces comprise differing interface modalities. Various interface modalities are known in the art and others will likely be developed going forward. An illustrative (though non-exhaustive) listing would likely include visually-based input and output interfaces, audibly-based input and output interfaces, haptically-based input and output interfaces (including, for example, touch-based and other contact-based interfaces), olfactorally-based input and output interfaces, and virtually-based input interfaces (including, for example, gesture-based, eye-position and/or gaze-direction-based interfaces and so forth).

By this process 100, such a device receives 101 non-user input regarding at least one environmentally-sourced operational constraint. This environmentally-sourced operational constraint may comprise, for example, a legal constraint, as when the constraint is one that must be observed as a matter of law. For example, usage of a cellular telephone to effect wide area wireless communications is presently prohibited by U.S. law aboard airborne U.S. flights. As another example, this environmentally-sourced operational constraint may comprise a societal constraint as where incoming call ringer annunciations are frowned upon, though not illegal, in a public theater setting.

There are various ways by which the device can receive such non-user input. For example, by one approach, the device can receive this input as a wireless transmission that comprises, at least in part, the non-user input. As another example, the device can receive this non-user input via an integral environmental sensor that senses one or more environmental conditions of relevance. These and other related mechanisms are known in the art. As the present teachings are relatively insensitive to the selection of any particular approach in this regard, for the sake of brevity and clarity further elaboration regarding the reception of such information will not be presented here.

In response to receiving such non-user input regarding at least one environmentally-sourced operational constraint, this process 100 then provides for automatically determining 102 a plurality of differing user interface operational configurations as will comply with the at least one environmentally-sourced operational constraint. By one approach, for example, this can comprise automatically determining one or more user interface operational configurations that comprise an alteration with respect to a presently enabled sequence of prompted user inputs. These prompted user inputs might comprise, for example, keypad assertions, voiced commands or the like, and so forth. This might comprise, for example, presenting a more detailed (and perhaps with more options being available) series of prompted user inputs in order to effect a particular device behavior. Similarly, for example, this might comprise presenting a less detailed (and perhaps with fewer options being available) series of prompted user inputs in order to effect that same particular device behavior.

By another approach, this might comprise automatically determining one or more user interface operational configurations that comprise an alteration with respect to a presently enabled interface modality. As but one illustration in this regard, this might comprise switching from a haptically-based interface modality to an audibly-based interface modality or vice versa.

By yet another approach, this might comprise automatically determining a user interface operational configuration that comprises an alteration with respect to a presently enabled interface control behavior. As but one illustration in this regard, for example, this might comprise altering a data input capability to constrain alphanumeric data-entry fields to accept only numeric information.

By one approach, one or more of these differing user interface operational configurations can be essentially constructed from scratch (using, for example, an informed understanding of the building block capabilities and functionalities of the device to build each use case). By another approach, one or more of these differing user interface operational configurations can be essentially, in whole or in part, predetermined (by, for example, the manufacturer, distributor, network administrator, user, or the like) and held in storage prior to their potential use and consideration as per these teachings. If desired, such candidates might be provided as part of a default set of candidate operational configurations or might be formed, at least in part, during an initial user training and calibration activity.

Other approaches are no doubt available as well with the above instantiations serving only as general illustrations in this regard. In general, this step 102 serves to automatically generate two or more different user interface operational configurations that, though potentially differing significantly from one another, each nevertheless serve to effect device compliance with the environmentally-sourced operational constraint. If desired, this step can further comprise assessing whether the operational constraint is recognized by the process/device. When such is not the case, this process 100 can terminate early or can take some other action to attempt to nevertheless address the constraint. For example, the device can prompt the user for assistance in this regard or might, if desired, unilaterally contact a remote resource such as a facilitation server that might be able to provide enabling information to the device regarding the unrecognized constraint.

This process 100 then provides for presenting 103 one or more of these automatically determined user interface operational configurations to a user of the device in order to prompt that user for an instruction regarding use of a selected one of the plurality of different user interface operational configurations. There are various ways by which the device can accomplish this step. By one approach, for example, the device can present, in an automated animated manner, each of the candidate operational configurations in seriatim fashion. By another approach, the device can present descriptive information regarding such candidates (such as a brief textual description, a brief audible description, a coded representation, a non-verbal graphic characterization, and so forth).

By one approach, this step can comprise notifying the user of such a presentation in order to attract the attention of the user. This might comprise an audible alert, for example, that uniquely corresponds to such a presentation.

Upon receiving 104 the sought-for instruction from the user, this process 100 then provides for using 105 that instruction to dynamically configure operation of the plurality of available user interfaces to accommodate the at least one environmentally-sourced operational constraint in a manner that is relatively satisfactory to the user. For example, in a given application setting, a particular device may automatically determine and present three different user interface operational configurations that will each meet the requirements posed by a particular environmentally-sourced operational constraint. To continue this example, the user may be supposed to have selected the second candidate user interface operational configuration. In such a case, the device will then dynamically adjust its operation to effect subsequent usage of that second candidate user interface operational configuration.

By this approach, a given user will have a choice (at least in some application settings) regarding how the device will accommodate a particular environmentally-sourced operational constraint. As these choices are automatically determined by the device itself, no particular skill or experience on the part of the user need serve as a prerequisite to experiencing such benefits.

By one approach, a given device can effect such a process 100 upon each encounter with an environmentally-sourced operational constraint. By another approach, if desired, a given device can effect this process 100 upon a first encounter with a particular category or kind of environmentally-sourced operational constraint. So configured, the device can be configured to automatically implement the corresponding user-selected user interface operational configuration when again subsequently encountering that same environ mentally-sourced operational constraint.

As noted above, this process 100 will employ a user-selected configuration approach to respond to a particular operational constraint. It is possible, in a given application setting, that a user may be unable to respond. Therefore, if desired, this process 100 can be configured to permit automatic selection of a particular candidate operational configuration (such as, for example, a first presented candidate operational configuration) in the event the user does not respond with the sought-for instruction within, for example, some allotted period of time.

The above example presumes that the operational constraint comprises an environmentally-sourced operational constraint. As noted, however, other sources are possible. For example, the operational constraint may comprise an internally-sourced operational constraint. As one example in this regard, a portable two-way wireless communication device may have power reduction requirements as an internally-sourced operational constraint that arise when reserve power capacity falls to a particular level. An illustrative (though incomplete and non-exhaustive) listing in this regard would include power reserve-based constraints, power usage-based constraints, temporally-based constraints, economically-based constraints (corresponding to, for example, pre-allotted durations of communication time and/or pre-allotted quantities of communicated data), administratively-based constraints (corresponding to, for example, parental blocking requirements or administrative content-based modality controls), and so forth.

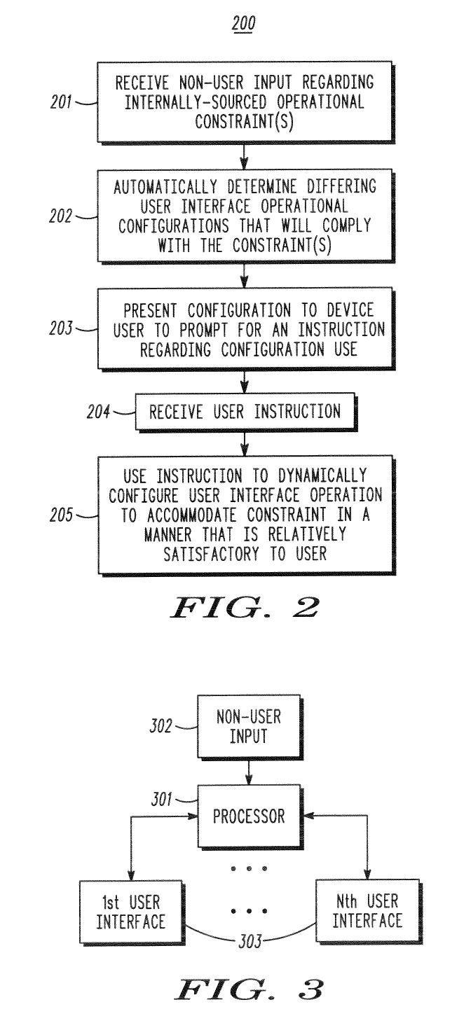

With reference to FIG. 2, a process 200 quite similar to that described above can also serve in conjunction with operational constraints that comprise environmentally-sourced operational constraints. Such a process 200 can provide, upon receiving 201 non-user input regarding at least one internally-sourced operational constraint, for automatically determining 202 a plurality of differing user interface operational configurations that will comply with the at least one internally-sourced operational constraint. This process 200 then provides for presenting 203 to a user of the corresponding device at least one of the plurality of different user interface operational configurations in order to again prompt the user for an instruction regarding use of, for example, a particular one of the candidate user interface operational configurations. Upon receiving 204 a user instruction in this regard, this process 200 then provides for using 205 that instruction to dynamically configure operation of the plurality of user interfaces as characterize this device to accommodate the at least one internally-sourced operational constraint in a manner that is again relatively satisfactory to the user.

This process 200 can be employed in combination with, or even in lieu of, the previously described process 100. When combining these processes 100 and 200, it would be possible to operate them in isolate from one another or with a higher degree of linkage. For example, when both an environmentally-sourced and an internally-sourced operational constraint are present, both processes 100 and 200 can be simultaneously effected to thereby determine a plurality of operational configurations that will satisfy both operational constraints such that any presented candidate as selected by the user will, in turn, satisfy both operational constraints.

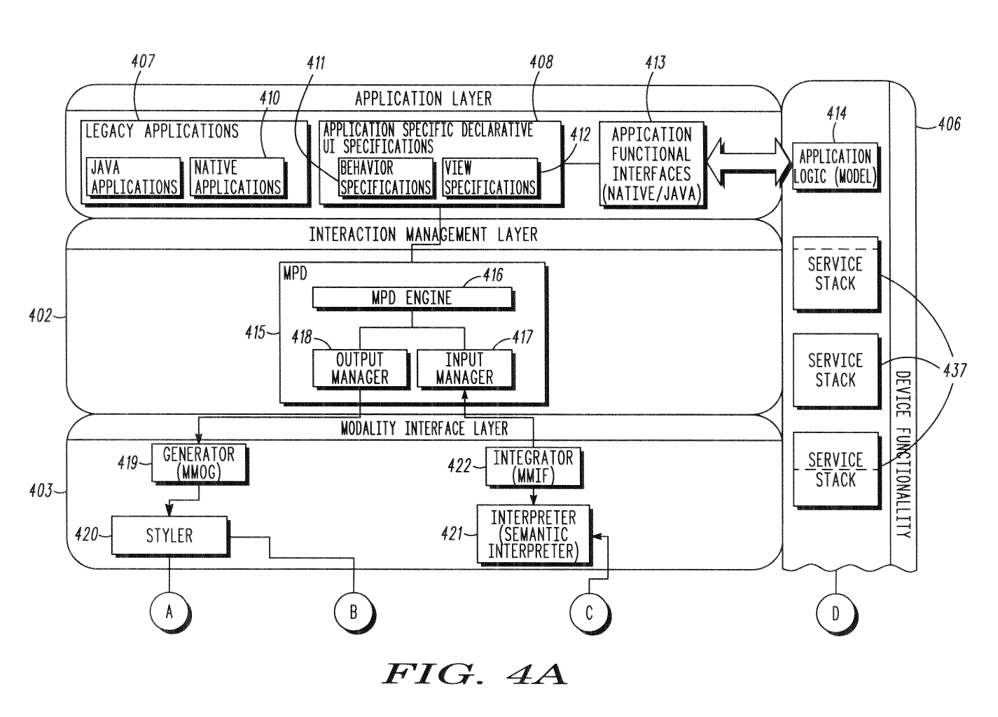

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment, a wireless two-way communications device 300 comprises, at least in part, a processor 301 that operably couples to a non-user input and to a plurality of user interfaces 303 (represented here by a first through an Nth user interface, where “N” comprises an integer greater than one) as have already been generally described and characterized above. The non-user input 302 can serve to receive environmentally-sourced operational constraint inputs, internally-sourced operational constraint inputs, or both as desired.

The processor 301 may comprise any suitable platform, including partially or wholly programmable platforms as well as dedicated-purpose platforms of choice. In this illustrative embodiment this processor 301 is configured and arranged (via, for example, corresponding programming) to effect selected steps as are set forth herein. This can comprise, for example, an ability to automatically determine the aforementioned plurality of differing user interface operational configurations as will comply with the operation constraint or constraints of the moment, to present such options to a user of the device 300 to thereby prompt that user for instructions regarding use of one or more of the candidate operational configurations, and to use such instructions to dynamically configure operation of the plurality of user interfaces 303 to accommodate that operational constraint or constraints in a manner that is relatively satisfactory to the user.

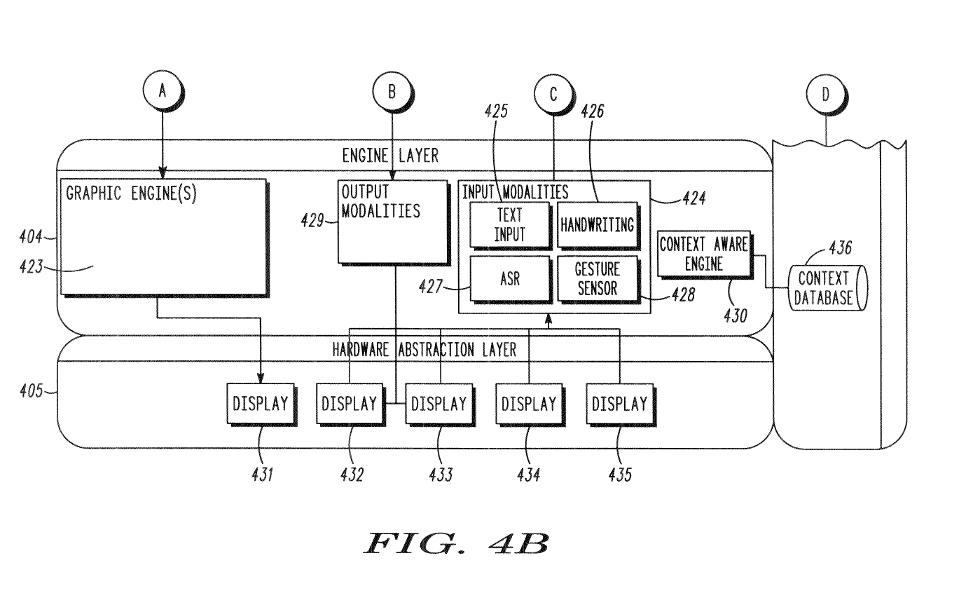

Referring to FIG. 4, a layer-based view of such an apparatus 300 can provide, for example, for an application layer 401, an interaction management layer 402, a modality interface layer 403, and an engine layer 404 as well as an embodying hardware layer 405 and a device functionality stack 406, The application layer 401 is responsible for hosting existing legacy applications 407, application specific declarative user interface (UI) specifications 408, and so forth as relate to user interface applications, background services, and the like. Illustrative examples of legacy applications 407 could include, but are not limited to, Java applications 409, native applications 410, and so forth.

Illustrative examples of application specific declarative UI specifications could include, hut are not limited to, declarative specifications for behaviors such as display screen flows 411, declarative specifications for the view 412 and so forth. These UI specifications for a wireless two-way communications device will typically vary, for example, with the corresponding carrier (such as Vodafone, Sprint, Verizon, Nextel, and so forth) and could comprise, for example, legacy applications, application specific Declarative U specifications (concerning, for example, both behavior specifications and presentation specifications), and application functional interfaces (as correspond, for example, to the legacy applications).

The application layer 401 can further comprise one or more application functional interfaces 413 to facilitate and support, for example, a Java and/or native based interface to application logic 414 as resides within the device functionality stack 406.

So configured, this application layer can provide for a clean separation between the behavior and presentation specifications (such that, for example, one can readily change application behavior separately from the presentation specifications and vice versa. This, in turn, can facilitate the aforementioned ability to dynamically change the user experience in response, for example, to environmentally-sourced operational constraints,

The interaction management layer 402 can comprise, for example, an application manager (such as a modular portable dialog (MPD) process 415) that generates and updates presentations by processing user inputs and possibly other external knowledge sources (such as, for example, a learning engine or context manager of choice) to determine user intent. This interaction management layer 402 is typically responsible for maintaining the interaction state and context of the application and responds to input from the user and to changes in the system by managing such changes and input and by coordinating input and output across the modality interface layer 403.

In this illustrative embodiment the interaction management layer 402 comprises an MPD engine 416 that interfaces with the modality interface layer 403 via corresponding input and output managers 417 and 418. This MPD engine 416 serves to author and execute multi-modal dialogs between the user and the device itself. By one approach this MPD engine 416 is configured and arranged to enable natural language dialogs and is further capable of managing non-linguistic input and output modalities (such as, but not limited to, graphical user interfaces).

The modality interface layer 403 can serve as an interface between semantic representations of information as processed by the interaction management layer 402 and modality specifications of content representations as processed by the engine layer 404. This modality interface layer 403 can comprise, for example, a generator component 419 that can generate more than one modality of output (such as a graphic output, a voice output, a text output, and so forth). This generator component 419 can be configured and arranged to accept different types of prompt representations and create appropriate markups for various modalities from such representations. This can be based, for example, upon translation capability and/or through a synthesis process (for example, by combining stored representations with partial prompt specifications (as when combining a stored screen representation with a partial description of a given screen field)). This generator component 419, in turn, can couple to a styler 420 that serves to add information about how information is being presented (via, for example, use of cascaded style sheet or voice cascaded style sheet as are known in the art).

A semantic interpreter 421 serves to transform user action into a carrier independent representation of the user action. For example, this can comprise transforming physical events into corresponding semantic events. An integrator 422 operably couples between the latter and the input manager 417 of the interaction management layer 402 and serves to fuse event from several separate modalities into a single logical event. This can comprise, at least in part, achieving modality state awareness, synchronization of differing modalities, and so forth.

The engine layer 404 serves generally to convert information from the interaction management layer 402 into a format that is presentable via a selected output modality 429 and that is understandable by the user. The engine layer 404 can comprise, for example, one or more graphic engines 423 that support the rendering of shapes, Bezier paths, and text, full linear two dimensional transformation (including, but not limited to, scaling, rotation, skewing, and so forth), anti-aliasing, alpha-blending, and image filtering, to note but a few. To illustrate, this graphics engine 423 can display a vector of points as a curved line while a speech synthesis system converts text into synthesized speech.

The engine layer 404 can further provide input modality capability 424 to facilitate the capture, for example, of natural input (such as text input 425, handwriting 426, automatic speech recognition 427, and gesture-based input 428) from a user via the hardware abstraction layer 405 and then translate that input into a form that is useful for later processing as per these teachings. By one approach, if desired, this engine layer 404 can comprise both rule based learning capabilities as well as a context aware engine 430 (wherein the latter would be responsible for learning the context as corresponds to user actions and to respond to user needs per appropriate constraints and context).

The hardware abstraction layer 405 serves generally to connect various hardware by means of corresponding device drivers such as, but not limited to, a display driver 431, an audio device driver 432, a touch screen driver 433, a keyboard driver 434, and/or a mouse (or other cursor control device) driver 435. The device functionality stack 406, in turn, can comprise a context database 436 to work in conjunction with the aforementioned context aware engine 430 as well as one or more service stacks 437 that provide information such as service provider-specific content.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, an apparatus such as a wireless two-way communications device can, when apprised of non-user operational constraints, determine a plurality of ways to accommodate those operational constraints and then facilitate the selection of a particular approach by the device user in order to better assure a relatively satisfactory user experience notwithstanding that operational constraint. Such benefits will tend to accrue notwithstanding a relatively inexperienced or non-expert user. Instead of forcing a particular predetermined response in every instance, these teachings permit, in effect, a kind of negotiation between the user and the device to facilitate selection of an accommodating approach that is, at least relative to other available options, most acceptable to that user.

As one illustrative example in this regard, a given device can receive a wireless broadcast upon entering a given area that provides information regarding locally prohibited and/or discouraged behaviors. This device then develops alternative solutions (while seeking, for example, to preserve as much latent and/or active functionality as possible) and permits the user to select a particular solution for use at this time.

By one approach the device has information regarding, for example, the relationships between its capabilities and the purpose of those capabilities. This, in turn, can permit the device to recognize what tasks may be changed or diminished when making changes to accommodate an operational constraint and also what other capabilities might help to otherwise resolve those tasks.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, if desired, these teachings will readily accommodate provision of a user-initiated or automated reversion capability. So configured, a device would have the ability to revert back to a previous configuration. This would provide a convenient and relatively intuitive mechanism to permit a device to assume a previous operational configuration once a given societal/legal constraint no longer applies. This approach would also permit a user to readily and quickly recover from a mistaken entry during the described process.

What is claimed is:

1. A method comprising:
at a wireless two-way communications device having a plurality of user interfaces wherein at least two of the plurality of user interfaces comprise differing interface modalities:
receiving non-user input regarding at least one environmentally-sourced operational constraint;
automatically determining a plurality of differing user interface operational configurations as will comply with the at least one environmentally-sourced operational constraint;
presenting to a user of the wireless two-way communications device at least one of the plurality of different user interface operational configurations in order to prompt the user for an instruction regarding use of the at least one of the plurality of different user interface operational configurations;
receiving the instruction from the user;
using the instruction to dynamically configure operation of the plurality of user interfaces to accommodate the at least one environmentally-sourced operational constraint in a manner that is relatively satisfactory to the user.

2. The method of claim 1 wherein the differing interface modalities comprise at least one of:
a visually-based output interface;
an audibly-based output interface;
a haptically-based output interface;
an olfactorally-based output interface;
a visually-based input interface;
an audibly-based input interface;
a haptically-based input interface;
an olfactorally-based input interface;
a virtually-based input interface.

3. The method of claim 1 wherein receiving non-user input regarding at least one environmentally-sourced operational constraint comprises at least one of:
receiving a wireless transmission comprising, at least in part, the non-user input;
receiving the non-user input via an integral environmental sensor.

4. The method of claim 1 wherein automatically determining a plurality of differing user interface operational configurations comprises, at least in part, automatically determining a user interface operational configuration that comprises an alteration with respect to a presently enabled sequence of prompted user inputs.

5. The method of claim 1 wherein automatically determining a plurality of differing user interface operational configurations comprises, at least in part, automatically determining a user interface operational configuration that comprises an alteration with respect to a presently enabled interface modality.

6. The method of claim 1 wherein automatically determining a plurality of differing user interface operational configurations comprises, at least in part, automatically determining a user interface operational configuration that comprises an alteration with respect to a presently enabled interface control behavior.

7. The method of claim 1 wherein the at least one environmentally-sourced operational constraint comprises at least one of:
a legal constraint;
a societal constraint.

8. The method of claim 1 further comprising:
receiving non-user input regarding at least one internally-sourced operational constraint;
automatically determining a plurality of differing user interface operational configurations as will comply with the at least one internally-sourced operational constraint;
presenting to a user of the wireless two-way communications device at least one of the plurality of different user interface operational configurations in order to prompt the user for an instruction regarding use of the at least one of the plurality of different user interface operational configurations;
receiving the instruction from the user;
using the instruction to dynamically configure operation of the plurality of user interfaces to accommodate the at least one internally-sourced operational constraint in a manner that is relatively satisfactory to the user.

9. The method of claim 8 wherein the at least one internally-sourced operational constraints comprises at least one of:
a power reserve-based constraint;
a power usage-based constraint;
a temporally-based constraint;
an economically-based constraint;
an administratively-based constraint.

10. A wireless two-way communications device comprising:
a plurality of user interfaces wherein at least two of the plurality of user interfaces comprise differing interface modalities;
an input configured and arranged to receive non-user input regarding at least one environmentally-sourced operational constraint;
a processor operably coupled to the plurality of user interfaces and the input and being configured and arranged to:
automatically determine a plurality of differing user interface operational configurations as will comply with the at least one environmentally-sourced operational constraint;
present to a user of the wireless two-way communications device at least one of the plurality of different user interface operational configurations in order to prompt the user for an instruction regarding use of the at least one of the plurality of different user interface operational configurations;
receive the instruction from the user;
use the instruction to dynamically configure operation of the plurality of user interfaces to accommodate the at least one environmentally-sourced operational constraint in a manner that is relatively satisfactory to the user.

11. The wireless two-way communications device of claim 10 wherein the differing interface modalities comprise at least one of:
a visually-based output interface;
an audibly-based output interface;
a haptically-based output interface;
an olfactorally-based output interface;
a visually-based input interface;
an audibly-based input interface;
a haptically-based input interface;
an olfactorally-based input interface;
a virtually-based input interface.

12. The wireless two-way communications device of claim 10 wherein the processor is further configured and arranged to receive non-user input regarding at least one environmentally-sourced operational constraint comprising at least one of:
a wireless transmission comprising, at least in part, the non-user input;
an integral environmental sensor.

13. The wireless two-wav communications device of claim 10 wherein the processor if further configured and arranged to automatically determine a plurality of differing user interface operational configurations by, at least in part, automatically determining a user interface operational configuration that comprises an alteration with respect to a presently enabled sequence of prompted user inputs.

14. The wireless two-way communications device of claim 10 wherein the processor is further configured and arranged to automatically determine a plurality of differing user interface operational configurations by, at least in part, automatically determining a user interface operational configuration that comprises an alteration with respect to a presently enabled interface modality.

15. The wireless two-way communications device of claim 10 wherein the processor is further configured and arranged to automatically determine a plurality of differing user interface operational configurations by, at least in part, automatically determining a user interface operational configuration that comprises an alteration with respect to a presently enabled interface control behavior.

16. The wireless two-way communications device of claim 10 wherein the at least one environmentally-sourced operational constraint comprises at least one of:
a legal constraint;
a societal constraint.

17. The wireless two-way communications device of claim 10 wherein the processor is further configured and arranged to:
receive non-user input regarding at least one internally-sourced operational constraint;
automatically determine a plurality of differing user interface operational configurations as will comply with the at least one internally-sourced operational constraint;
present to a user of the wireless two-way communications device at least one of the plurality of different user interface operational configurations in order to prompt the user for an instruction regarding use of the at least one of the plurality of different user interface operational configurations;
receive the instruction from the user;
use the instruction to dynamically configure operation of the plurality of user interfaces to accommodate the at least one internally-sourced operational constraint in a manner that is relatively satisfactory to the user.

18. The wireless two-way communications device of claim 17 wherein the at least one internally-sourced operational constraint comprises at least one of:
a power reserve-based constraint;
a power usage-based constraint;
a temporally-based constraint;
an economically-based constraint;
an administratively-based constraint.

19. The wireless two-way communications device of claim 10 wherein the processor comprises means for:
receiving the non-user input;
automatically determining the plurality of differing user interface operational configurations;
presenting to a user of the wireless two-way communications device at least one of the plurality of different user interface operational configurations in order to prompt the user for an instruction regarding use of the at least one of the plurality of different user interface operational configurations;
receiving the instruction from the user;
using the instruction to dynamically configure operation of the plurality of user interfaces to accommodate the at least one environmentally-sourced operational constraint in a manner that is relatively satisfactory to the user.
